(19) United States
(12) Patent Application Publication
(10) Pub. No.: US 2018/0262907 A1
(43) Pub. Date: Sep. 13, 2018

(54) LOCATION BASED AUTHENTICATION VERIFICATION FOR INTERNET OF THINGS

(71) Applicant: International Business Machines Corporation, Armonk, NY (US)

(72) Inventors: Francisco J. Alanis, Cedar Park, TX (US); Edgar O. Cantu, Round Rock, TX (US); Maria deLourdes Garza, Round Rock, TX (US); Carlos F. Gomez, Pflugerville, TX (US)

(21) Appl. No.: 15/455,194

(22) Filed: Mar. 10, 2017

(51) Int. Cl. H04W 12/06; H04W 12/08; H04W 4/02

(52) U.S. Cl. CPC H04W 12/06; H04W 80/04; H04W 4/02; H04W 12/08

(57) ABSTRACT

A mobile device is used to access internet connected devices such as IoT devices. The mobile device's location tracking features are used to supplement traditional authentication methods with geolocation metadata to allow access of the mobile device to the internet connected devices.

### BACKGROUND

The present invention relates to location based authentication verification, and more specifically to location based authentication verification for internet of things (IoT) devices.

One of the most important aspects of the Internet of Things (IoT) is its security. Internet of things (IoT) is the internetworking of physical devices, (also referred to as “connected devices” and “smart devices”), buildings, and other items—embedded with electronics, software, sensors, actuators, and network connectivity that enable these objects to collect and exchange data. In some cases, the devices, buildings and other items can be accessed by unauthorized users, compromising the security associated with these devices and data collected by these devices.

### SUMMARY

According to one embodiment of the present invention, a method of authenticating access of a mobile device to an internet connected device comprising is disclosed. The method comprising the steps of: the internet connected device receiving a request for access from the mobile device having an internet protocol address; the internet connected device querying an internet protocol geolocation database for a first location associated with the internet protocol address of the request from the mobile device; the internet connected device querying a location tracking server for a second location associated with the mobile device; and the internet connected device verifying whether the first location and the second location are within a range threshold.

According to another embodiment of the present invention, a method of authenticating access of a mobile device to an internet connected device is disclosed. The method comprising the steps of: the internet connected device receiving a request for access from the mobile device having an internet protocol address and an encrypted global positioning system location; the internet connected device querying an internet protocol geolocation database for a first location associated with the internet protocol address of the request from the mobile device; the internet connected device decrypting the encrypted global positioning system location from the request using a private key specific to the mobile device to generate a second location; the internet connected device verifying whether the first location and the second location are within a range threshold.

According to another embodiment of the present invention, a computer program product for authenticating access of a mobile device to an internet connected device is disclosed. The internet connected device comprising at least one processor, one or more memories, one or more computer readable storage media, the computer program product comprising a computer readable storage medium having program instructions embodied therewith. The program instructions executable by the computer to perform a method comprising: receiving, by the internet connected device, a request for access from the mobile device having an internet protocol address; querying, by the internet connected device, an internet protocol geolocation database for a first location associated with the internet protocol address of the request from the mobile device; querying, by the internet connected device, a location tracking server for a second location associated with the mobile device; and verifying, by the internet connected device, whether the first location and the second location are within a range threshold.

According to another embodiment of the present invention, a computer system for authenticating access of a mobile device to an internet connected device is disclosed. The internet connected device comprising a computer comprising at least one processor, one or more memories, one or more computer readable storage media having program instructions executable by the computer to perform the program instructions. The program instructions comprising: receiving, by the internet connected device, a request for access from the mobile device having an internet protocol address; querying, by the internet connected device, an internet protocol geolocation database for a first location associated with the internet protocol address of the request from the mobile device; querying, by the internet connected device, a location tracking server for a second location associated with the mobile device; and verifying, by the internet connected device, whether the first location and the second location are within a range threshold.

According to another embodiment of the present invention, a computer program product for authenticating access of a mobile device to an internet connected device is disclosed. The internet connected device comprising a computer comprising at least one processor, one or more memories, one or more computer readable storage media having program instructions executable by the computer to perform the program instructions. The program instructions comprising: receiving, by the internet connected device, a request for access from the mobile device having an internet protocol address and an encrypted global positioning system location; querying, by the internet connected device, an internet protocol geolocation database for a first location associated with the internet protocol address of the request from the mobile device; decrypting, by the internet connected device, the encrypted global positioning system location from the request using a private key specific to the mobile device to generate a second location; verifying, by the internet connected device, whether the first location and the second location are within a range threshold.

According to another embodiment of the present invention, a computer system for authenticating access of a mobile device to an internet connected device is disclosed. The internet connected device comprising a computer comprising at least one processor, one or more memories, one or more computer readable storage media having program instructions executable by the computer to perform the program instructions. The program instructions comprising: receiving, by the internet connected device, a request for access from the mobile device having an internet protocol address and an encrypted global positioning system location; querying, by the internet connected device, an internet protocol geolocation database for a first location associated with the internet protocol address of the request from the mobile device; decrypting, by the internet connected device, the encrypted global positioning system location from the request using a private key specific to the mobile device to generate a second location; verifying, by the internet connected device, whether the first location and the second location are within a range threshold.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a schematic of interaction between a mobile device, the internet connected device, the geolocation database and the tracking service.

FIG. 3 shows a method of verifying IoT through location authentication.

FIG. 4 depicts an exemplary diagram of a possible data processing environment in which illustrative embodiments may be implemented.

### DETAILED DESCRIPTION

In an embodiment of the present invention, a mobile device can be used to access internet connected devices such as IoT devices, and using the mobile device's location tracking features to supplement traditional authentication methods with geolocation metadata to allow access of the mobile device to the internet connected devices.

In the present example, the physical device of the IoT is the Internet Connected Device (ICD) and the device computer is a mobile or personal device.

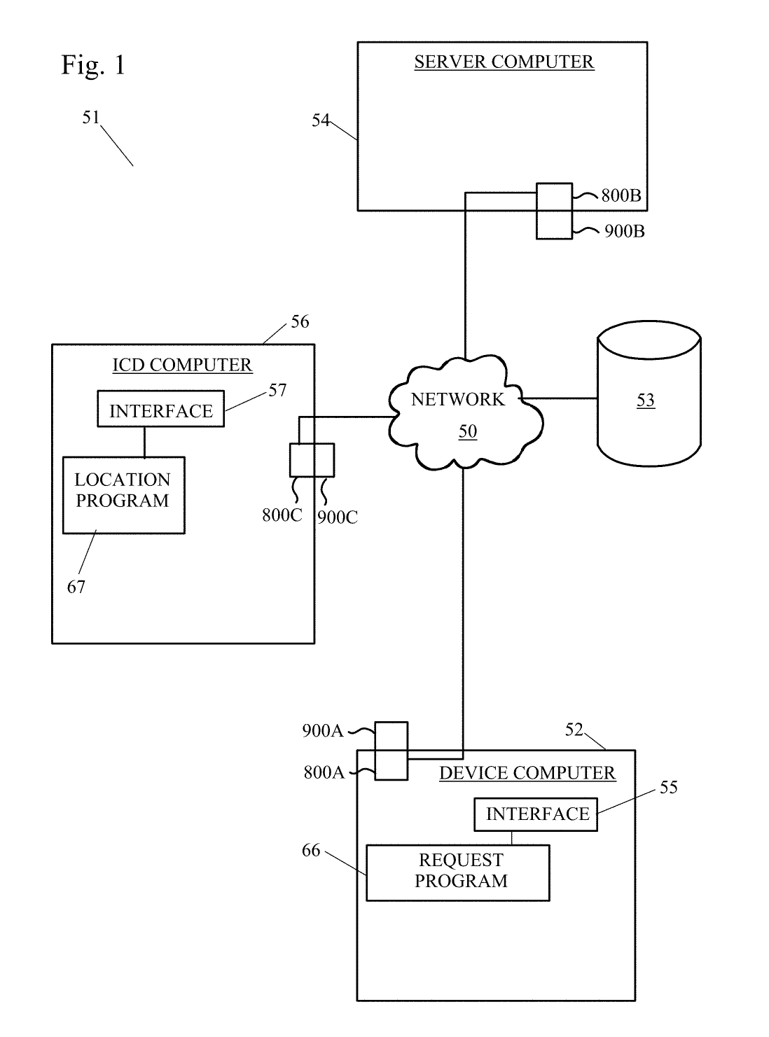

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, an Internet connected device (ICD) 56, a repository 53, and a server computer 54 connect to network 50. In other exemplary embodiments, network data processing system 51 may include additional client or device computers, storage devices or repositories, server computers, and other devices not shown.

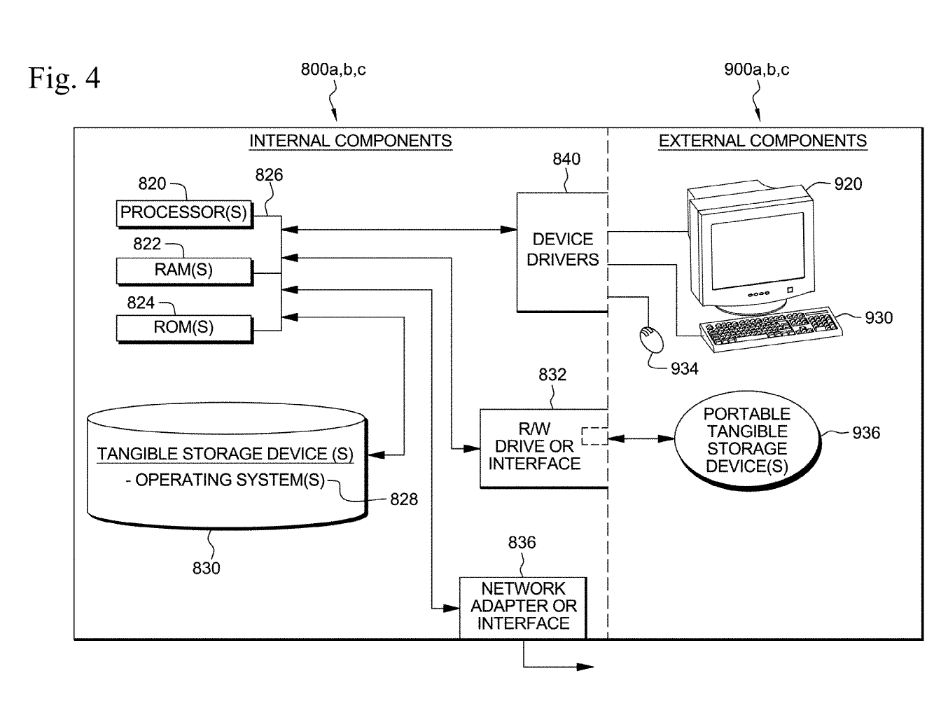

The device computer 52 may be a mobile device or a personal device. The device computer 52 may contain an interface 55, which may accept commands and data entry from a user. The commands may be regarding authorization requests or other information identifying a user for authorization to access an ICD computer 56. The interface 55 can be, for example, a command line interface, a graphical user interface (GUI), a natural user interface (NUI) or a touch user interface (TUI). The device computer 52 preferably includes a request program 66. The device computer 52 includes a set of internal components 800a and a set of external components 900a, further illustrated in FIG. 4.

The ICD computer 56 may contain an interface 57. The ICD computer 56 preferably includes a location program 67, which may accept commands and data entry from a user via the device computer 52. The commands may be regarding authorization requests and information regarding tracking a location of the device computer 52. The interface 57 can be, for example, a command line interface, a graphical user interface (GUI), a natural user interface (NUI), a touch user interface (TUI) or a remote interface on a separate device. The ICD computer 56 includes a set of internal components 800c and a set of external components 900c, further illustrated in FIG. 4.

Server computer 54 includes a set of internal components 800b and a set of external components 900b illustrated in FIG. 4. In the depicted example, server computer 54 provides information, such as boot files, operating system images, and applications to the device computer 52 and ICD computer 56. The server computer 54 can include a tracking service or be in communication with a tracking service. Server computer 54 can compute the information locally or extract the information from other computers on network 50.

Program code and programs such as request program 66 and location program 67 may be stored on at least one of one or more computer-readable tangible storage devices 830 shown in FIG. 4, on at least one of one or more portable computer-readable tangible storage devices 936 as shown in FIG. 4, or on storage unit 53 connected to network 50, or may be downloaded to a device computer 52, the ICD computer 56, or server computer 54, for use. For example, program code and programs such as request program 66 and location program 67 may be stored on at least one of one or more storage devices 830 on server computer 54 and downloaded to device computer 52, and/or ICD computer 56 over network 50 for use. Alternatively, server computer 54 can be a web server, and the program code, and programs such as request program 66 and location program 67 may be stored on at least one of the one or more storage devices 830 on server computer 54 and accessed by device computer 52 and ICD computer 56. In other exemplary embodiments, the program code, and programs such as request program 66 and location program 67 may be stored on at least one of one or more computer-readable storage devices 830 on device computer 52 or ICD computer 56 or distributed between two or more servers.

Store unit or repository 53 may contain a geolocation database.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

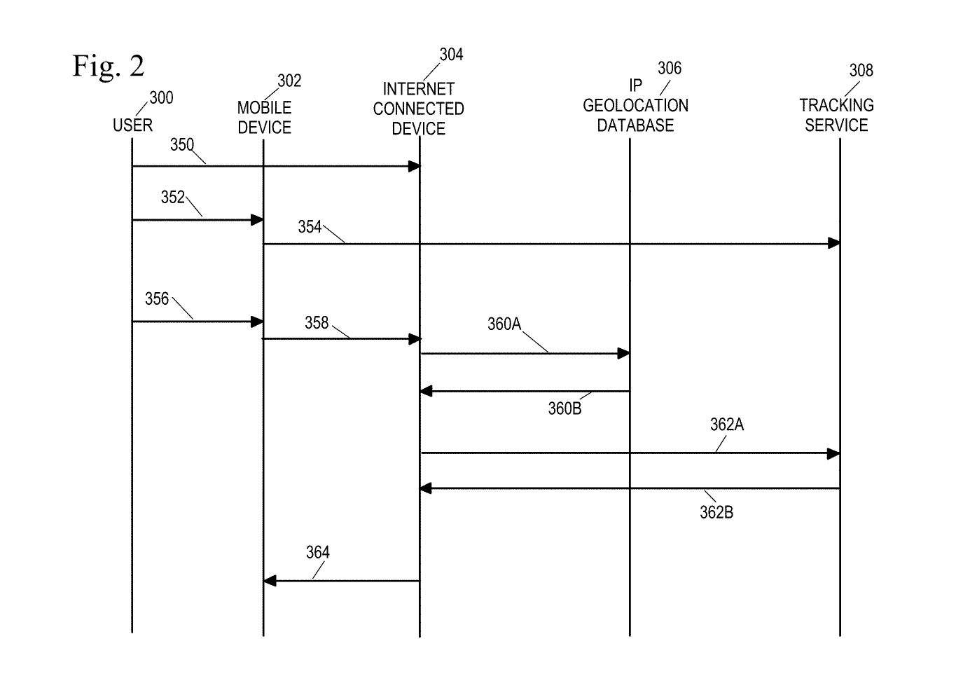

FIG. 2 shows a schematic of interactions between a mobile device, the internet connected device, the geolocation database and the tracking service of a geolocation authorization system.

A user 300 interacts with the mobile device 302, which may be the device computer 52 of FIG. 1 and the internet connected device (ICD) computer 304, 56 to configure the devices for use.

The configuration can be initiated by the user to step up a location tracking service on the ICD for each mobile device 52, 302 which would have access to the ICD 304 as indicated by line 350. The configuration includes the mobile device sending identification information, which uniquely identifies each of the mobile devices to the ICD. For example, an International Mobile Equipment Identity (IMEI), a unique 15-digit serial number given to every mobile device which can then be used to check information such as the phone's Country of Origin, the Manufacturer and Model Number of the mobile device. Internet protocol (IP) geolocation access data from the mobile device can also be sent to the ICD 304. Other configuration data, such as user name and password, authentication key or token setup for each mobile device may also be sent to the ICD 304. Additionally, the threshold distance range can be set by the user 300. The threshold distance range is preferably set through physical access by the user 300 to the ICD 304.

The mobile device 302 may also be configured by installing an application on the mobile device 302 which includes the request program 66 as indicated by line 352. In one embodiment, the configuration of the ICD 304 may be carried out through the application installed on the mobile device 302 when the mobile device is connected to a same local area network as the ICD 304.

Additionally, the mobile device 302 may be configured and enrolled in a custom location tracking service 308, for example using a location based identification (LBID) server or other technology which uses location for identification, instead of a location tracking system inherent to the software system of the mobile device 302.

The mobile device 302 is preferably connected to a tracking service 308. The mobile device 302 sends periodic updates of its location to the tracking service 308 as indicated by line 354.

The ICD 304 is connected to an IP Geolocation database 306 which stores IP location for the mobile device 302.

When a request is made by a user (line 356) through a mobile device 302 to access the ICD 304, the mobile device 302 sends the request to the ICD 304 (line 358). The ICD 304 obtains its current internet protocol address. The ICD 304 then queries an IP geolocation database 306 (line 360A) to obtain the source IP location of the mobile device 302 which initiated the request (line 360B).

The ICD 304 then queries (line 362A) the tracking service 308 in which the mobile device 302 periodically updates its current location. The mobile device's current location from the tracking service 308 is then sent back to the ICD 304 (line 362B). The ICD 304 verifies that the IP location and the mobile device's current location are within a threshold distance range, such as a configurable distance range of each other. The threshold distance range is at a zip code to city level and represents a geolocation or estimation of the real-world geographic location of the ICD 304. The threshold distance range may be 0.1 to 0.5 miles. If the distance between the mobile device's current location and the IP location of the ICD 304 is within the predetermined threshold range, the authorization can continue and additional authorization or a grant of access can be sent to the mobile device 302 from the ICD 304 (line 364).

It should be noted that the method of location based authentication verification of IoT devices or internet connected devices (ICD) is more accurate when the mobile device is global positioning system (GPS) enabled.

The location based authentication verification can modify the distance range which is acceptable (threshold) when the GPS signal of the mobile device 302 is lost or unavailable. At times, GPS signals are lost due to sky visibility, location, weather and other factors. The mobile device 302 is aware of the current GPS signal strength and this information can be sent along with the request to access the ICD 304. The current GPS signal strength can be used to increase or decrease the location as represented by the geolocation and as represented by the tracking service, with both the locations correspond to the location of the mobile device.

Additionally, if the GPS signal is completely lost, GPS history stored by the mobile device 302 can be utilized to create a reasonable origin and radius of where the user and the associated mobile device 302 is located based on direction, and speed. The calculated radius of that sphere can be used as an acceptable range within given parameters. The effectiveness of the estimates regarding location can decrease over a time period so that the commands being requested by the ICD 304 are limited when the GPS signal is completely lost.

In an alternative embodiment, the tracking service 308 can be replaced with GPS locations which are encrypted through keys exchange during initial configuration between the mobile device 302 and the ICD 304, for example via a secure sockets layer (SSL). For example, if a user does not want to share GPS location information with the third party tracking service or if the tracking service is unavailable, instead of the mobile device 302 sending periodic location information to such a server of a tracking service 308, the mobile device 302 would encrypt its GPS coordinates and store them within local memory of the mobile device 302. Encryption of the GPS coordinates can be executed using a public key provided by the ICD 304 and established during configuration. When a request is made to the ICD 304 from the mobile device 302, the encrypted location of the mobile device would be sent with the request. The ICD 304 would then decrypt the coordinates using a private key, instead of requesting the IP location from a tracking service 308.

In another embodiment, a salt vector location can be used when encrypted GPS coordinates are sent from the mobile device 302 to the ICD 304 for additional privacy. For example, within an established time period, the request program 66 of the mobile device 302 and the ICD 304 could exchange salt vectors which are added to the location data. In this example, the mobile device has to add the salt vector to the location information prior to sending the data to the ICD 304. Once the ICD 304 receives the information, the ICD 304 has to remove the salt vector to obtain the actual location information to then send to the IP geolocation database 306.

In another embodiment, the salt vector is added to the location information when using encrypted GPS coordinates, but only when the tracking service is unavailable to the mobile device 302. For example, the location with a salt vector would only be exchanged when the tracking service 308 is available. When and if the tracking service 308 becomes unavailable, the last salt vector which was exchanged is used.

In yet another embodiment, authentication may be less rigorous when the mobile device sends location data indicating that the mobile device 302 is in a home location. The home location may be established by the user 300 during configuration. For example, the ICD 304 may skip the GPS verification when the IP of the mobile device attempting to access the ICD 304 is established as a trusted network. The trusted network can be in any location set by the user, for example a home network, a work network, and so on. When the mobile device and the ICD are in the same local network, no further GPS verification would be required. This also allows the system to only accept certain high risk or administrative commands when they are coming from the local network.

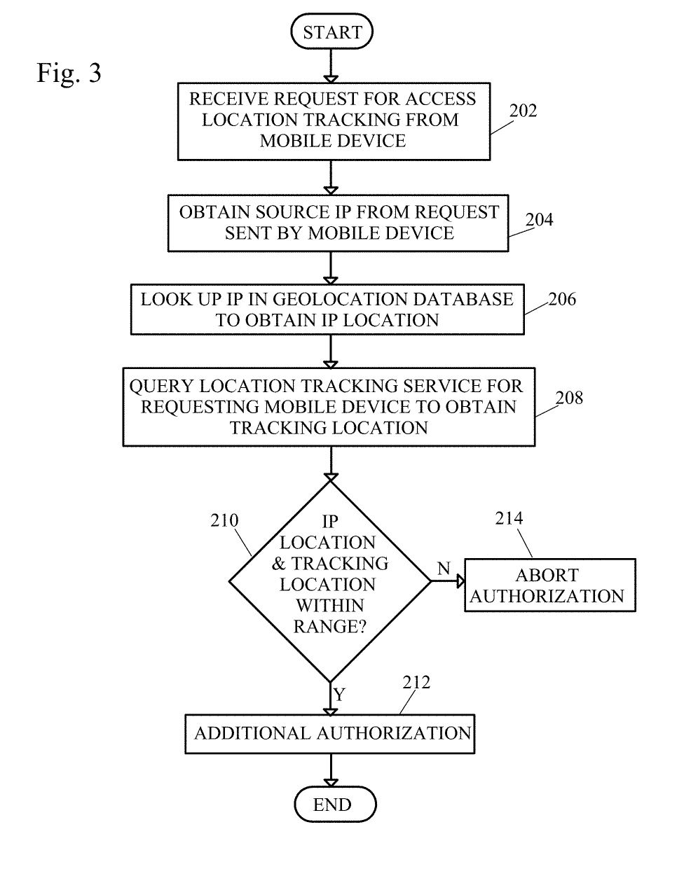

FIG. 3 shows a method of verifying IoT through location authentication.

In a first step, an ICD receives a request for controlling the ICD from a mobile device (step 202). The request may preferably include credentials provided by the user, such as username and password, and other metadata, for example unique identifying information associated with the mobile device, such as the IMEI number.

The ICD obtains a source IP from the request sent by the mobile device (step 204).

The ICD searches for the source IP in the geolocation database to obtain an IP location (step 206). The ICD then queries a location tracking service to request a tracking location of the mobile device which requested access to the ICD (step 208).

If the IP location and tracking location are within a range or configured threshold (step 210), authentication of the user proceeds for accessing the ICD (step 212) and the method ends. The additional authentication may be through an authorization key, token or other conventional means of authentication.

If the IP location and tracking location are not within range or the configured threshold (step 210), authorization is aborted (step 214) and the method ends. Prior to the method ending, the failed authorization or access of the ICD may be stored in the ICD.

FIG. 4 illustrates internal and external components of a device computer 52, an ICD computer 56, and server computer 54 in which illustrative embodiments may be implemented. In FIG. 4, a device computer 52, a server computer 54, and an ICD computer 56 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, request program 66 and location program 67 are stored on one or more of the computer-readable tangible storage devices 830 for execution by one or more of the processors 820 via one or more of the RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Request program 66 and location program 67 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. Request program 66 and location program 67 can be downloaded to the device computer 52, server computer 54, and ICD computer 56 from an external computer via a network (for example, the Internet, a local area network or other, wide area network) and network adapter or interface 836. From the network adapter or interface 836, context program 66 is loaded into hard drive 830. Request program 66 and location program 67 can be downloaded to the server computer 54 from an external computer via a network (for example, the Internet, a local area network or other, wide area network) and network adapter or interface 836. From the network adapter or interface 836, context program 66 is loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Request program 66 and location program 67 can be written in various programming languages including low-level, high-level, object-oriented or non object-oriented languages. Alternatively, the functions of a context program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of authenticating access of a mobile device to a physical internet connected device interconnected to a plurality of other physical interconnected devices as an Internet of Things device comprising the steps of:
the physical internet connected device receiving identification information of an International Mobile Equipment Identity (IMEI) number to uniquely identify each of the mobile devices which can access the physical internet connected device;
the physical internet connected device receiving a request for access from the mobile device having an internet protocol address;
the physical internet connected device querying an internet protocol geolocation database for a first location associated with the internet protocol address of the request from the mobile device;
the physical internet connected device querying a location tracking server for a second location associated with the mobile device;
the physical internet connected device determining whether the first location and the second location are within a range threshold; and
the physical internet connected device allowing access by the mobile device when the physical interconnected device determines that the first location and the second location are within the range threshold.

2. The method of claim 1, wherein the mobile device periodically sends location tracking data to the location tracking server.

3. The method of claim 1, wherein when the physical interconnected device determines that the first location and the second location are not within a range threshold, access to the internet connected device by the mobile device is denied.

4. The method of claim 1, wherein the range threshold is modified to be larger when a global positioning system signal of the mobile device is unavailable.

5. (canceled)

6. The method of claim 1, wherein the identification information further comprises information selected from a group consisting of: Internet protocol geolocation access data, username, password, authentication key, and tokens.

7. (canceled)

8. (canceled)

9. (canceled)

10. (canceled)

11. (canceled)

12. (canceled)

13. (canceled)

14. A computer program product for authenticating access of a mobile device to a physical internet connected device interconnected to a plurality of other physical interconnected devices as an Internet of Things device, the internet connected device comprising at least one processor, one or more memories, one or more computer readable storage media, the computer program product comprising a computer readable storage medium having program instructions embodied therewith, the program instructions executable by the computer to perform a method comprising:
receiving, by the physical internet connected device, identification information of an International Mobile Equipment Identity (IMEI) number to uniquely identify each of the mobile devices which can access the physical internet connected device;
receiving, by the physical internet connected device, a request for access from the mobile device having an internet protocol address;
querying, by the physical internet connected device, an internet protocol geolocation database for a first location associated with the internet protocol address of the request from the mobile device;
querying, by the physical internet connected device, a location tracking server for a second location associated with the mobile device;
determining, by the physical internet connected device, whether the first location and the second location are within a range threshold; and
allowing access to the internet connected device by the mobile device when the physical interconnected device determines that the first location and the second location are within the range threshold.

15. The computer program product of claim 14, wherein the mobile device periodically sends location tracking data to the location tracking server.

16. The computer program product of claim 14, wherein when the physical interconnected device determines that the first location and the second location are not within a range threshold, access to the internet connected device by the mobile device is denied.

17. The computer program product of claim 14, wherein prior to the program instructions of determining, by the physical internet connected device, whether the first location and the second location are within a range threshold, further comprising the program instructions of determining whether a global positioning system signal of the mobile device is unavailable and when the global positioning system signal of the mobile device is unavailable, modifying the range threshold to be larger.

18. (canceled)

19. The computer program product of claim 14, wherein the identification information further comprises information selected from a group consisting of: Internet protocol geolocation access data, username, password, authentication key, and tokens.

20. A computer system for authenticating access of a mobile device to a physical internet connected device interconnected to a plurality of other physical interconnected devices as an Internet of Things device, the physical internet connected device comprising a computer comprising at least one processor, one or more memories, one or more computer readable storage media having program instructions executable by the computer to perform the program instructions, the program instructions comprising:
receiving, by the physical internet connected device, identification information of an International Mobile Equipment Identity (IMEI) number to uniquely identify each of the mobile devices which can access the physical internet connected device;
receiving, by the physical internet connected device, a request for access from the mobile device having an internet protocol address;
querying, by the physical internet connected device, an internet protocol geolocation database for a first location associated with the internet protocol address of the request from the mobile device;
querying, by the physical internet connected device, a location tracking server for a second location associated with the mobile device;
determining, by the physical internet connected device, whether the first location and the second location are within a range threshold; and
allowing access to the internet connected device by the mobile device when the physical interconnected device determines that the first location and the second location are within the range threshold.

21. The computer system of claim 20, wherein the mobile device periodically sends location tracking data to the location tracking server.

22. The computer system of claim 20, wherein when the physical interconnected device determines that the first location and the second location are not within the range threshold, access to the internet connected device by the mobile device is denied.

23. The computer system of claim 20, wherein prior to the program instructions of determining, by the physical internet connected device, whether the first location and the second location are within a range threshold, further comprising the program instructions of determining whether a global positioning system signal of the mobile device is unavailable and when the global positioning system signal of the mobile device is unavailable, modifying the range threshold to be larger.

24. The computer system of claim 20, wherein the identification information further comprises information is selected from a group consisting of: Internet protocol geolocation access data, username, password, authentication key, and tokens.
